(19) United States
(12) Patent Application Publication
(10) Pub. No.: US 2010/0287910 A1
(43) Pub. Date: Nov. 18, 2010

(54) NACELLE WITH SIMPLIFIED COWLING ARRANGEMENT

(75) Inventors: Jean-Philippe Joret, Beuzeville (FR); Andre Baillard, Bretteville du Grand Caux (FR); Gerard Clere, Clamart (FR)

Correspondence Address: CANTOR COLBURN LLP, 20 Church Street, 22nd Floor, Hartford, CT, 06103, US

(73) Assignee: AIRCELLE, Gonfreville l'Orcher (FR)

(21) Appl. No.: 12/812,621

(22) PCT Filed: Oct. 3, 2008
(86) PCT No.: PCT/FR08/01390

§ 371 Date: Jul. 13, 2010

(30) Foreign Application Priority Data
Jan. 15, 2008 (FR) 08/00196

(51) Int. Cl. F02K 3/02; F01D 25/24

(52) U.S. Cl. 60/226.2; 415/214.1

(57) ABSTRACT

The invention relates to a nacelle (1) that comprises a first cowling (7) and a second cowling (9) capable of covering in particular the area (15) located around the casing of the fan (19) of a turbojet engine (3). The nacelle further includes an intermediate cowling (23) attached to said first cowling (7) so as to sandwich a mast (5) holding said turbojet engine (3). The second cowling (9) is mounted onto the intermediate cowling (23) via removable fastening means.

TECHNICAL FIELD

The present invention concerns a nacelle with a simplified cowling arrangement.

### BACKGROUND

In FIGS. 1 to 4, we have illustrated a nacelle 1 of the prior art, surrounding a turbojet engine 3 fixed on a mast 5.

Such a nacelle typically comprises a fixed upper cowling 7 and a lower cowling 9 mounted pivotably on said upper cowling owing to hinges 11, with bolts 13 being provided to lock/unlock the lower cowling for maintenance operations of the members found in the peripheral zone 15 situated between the air inlet 17, the casing of the fan 19 and the thrust reverser 21.

Such a nacelle therefore requires the implementation of hinges and bolts, as well as rods making it possible to maintain the lower cowling 9 in the open position.

These articulation, locking and maintenance members have the drawback of putting a strain on the weight and cost of the assembly.

### BRIEF SUMMARY

The present invention therefore aims in particular to provide a nacelle of the abovementioned type which has a lower weight and lower cost.

This aim of the invention is achieved with a nacelle comprising a first cowling and a second cowling capable of covering in particular the zone situated around the casing of the fan of a turbojet engine, remarkable in that it also comprises an intermediate cowling fixed to said first cowling so as to sandwich a support mast of said turbojet engine, and in that said second cowling is attached on said intermediate cowling by removable fastening means.

Owing to these features, the first cowling and the intermediate cowling constitute fixing supports for the second cowling, and when one wishes to access said zone, one need only disassemble the second panel and remove it completely.

No articulation, bolt or maintenance rod is necessary: in this way one saves weight, gains simplicity and lowers the cost.

According to other optional features of the nacelle according to the invention:
said nacelle also comprises axial fixing pins of said first cowling and/or of said second cowling and/or of said intermediate cowling on a downstream part of said nacelle, such as a thrust reverser,
said nacelle also comprises removable fixing means of said first cowling and/or of said second cowling and/or of said intermediate cowling on an upstream part of said nacelle, such as an air inlet;
said nacelle comprises locking means of said first cowling and/or of said second cowling and/or of said intermediate cowling on an upstream part of said nacelle, such as an air inlet;
said removable fixing means comprises screws cooperating with nut casings;
the means for fixing said intermediate cowling to said first cowling comprises fittings mounted on said cowlings and rods extending between said fittings;
joints are fixed on the edges of said intermediate cowling and said first cowling that are designed to cooperate with said mast;
said first cowling is an upper cowling and said second cowling is a lower cowling;
said cowlings comprise reinforcing means.

### BRIEF DESCRIPTION OF THE DRAWINGS

Other features and advantages of the present invention will appear in light of the following description, and upon examination of the appended figures, in which:

FIGS. 1 to 4 designate a nacelle of the prior art; more particularly, FIGS. 1 and 2 are perspective views of such a nacelle in the normal operating position and in maintenance position, respectively, FIG. 3 is an axial cross-sectional view of said nacelle along the plane P of FIG. 1 observed along the direction III, and FIG. 4 is a transverse cross-sectional view of said nacelle along line IV-IV of FIG. 3,
FIG. 5 is an exploded perspective view of a nacelle according to the invention,
FIGS. 6 to 8 are perspective views of an upper cowling, an intermediate cowling and a lower cowling of the nacelle of FIG. 5,
FIGS. 9 and 10 are views similar to those of FIGS. 3 and 4 of the nacelle according to the invention, in the normal operating position,
FIGS. 11 to 14 are views similar to that of FIG. 9, indicating the opening kinematics of the lower cowling of the nacelle according to the invention,
FIG. 15 is a view similar to that of FIG. 10, corresponding to the opening state of the cowling 9 of FIG. 14, and
FIG. 16 is a view similar to that of FIG. 9 of another embodiment of a nacelle according to the invention.

In all of these figures, identical or similar numerical references designate identical or similar members or sets of members.

### DETAILED DESCRIPTION

In reference now to FIGS. 5 to 8, one can see that the nacelle according to the invention comprises a cowling including three distinct parts: an upper cowling 7, a lower cowling 9 and an intermediate cowling 23.

The upper 7 and lower 9 cowlings essentially have the shape of half cylinders and include, on their internal faces, reinforcements in the form of ribs 25, 27. The intermediate cowling 23 is essentially in the form of a plate, also provided on its inner face with reinforcements 29.

These three cowlings include, on their downstream edge (relative to the direction of circulation of the air in the turbojet engine 3), axial pins 31, 33, 35, the function of which will be explained below.

The upper cowling 7 and the intermediate cowling 23 also include fittings 37, 39, connected together in pairs by rods 41.

One can also see in FIG. 8 that the lower cowling 9 includes, on its two longitudinal edges, a plurality of perforations 43, 45 designed to allow the attachment of said lower cowling on the corresponding edges of the upper cowling 7 and the intermediate cowling 23, respectively.

In reference to FIG. 9, one can see that the axial pins 33 of the lower cowling 9 cooperate with the receptacles 47 fixed on the thrust reverser 21.

The upstream edge of the lower cowling 9 is fixed on angle irons 49 mounted on the air inlet 17, owing to fastening members such as screws 51 cooperating with nut casings 53.

One can also see in FIG. 10 that such screws 51 and casings 53 are also used to fasten the lateral edges of the lower cowling 9 to the corresponding edges of the upper cowling 7 and the intermediate cowling 23.

FIG. 10 also shows the manner in which the rods 41 extend between the fittings 37 of the upper cowling 7 and the fittings 39 of the intermediate cowling 23.

It will also be noted, as shown in this figure, that joints 55, 57 are fastened on the lateral edges of the upper cowling 7 and the intermediate cowling 23 cooperating with the mast 5; the reverse is possible, i.e. the joints can be fastened on the mast 5 and rest on the upper cowling 7 and the intermediate cowling 23.

When one wishes to access the peripheral zone 15 surrounding the casing of the fan 19, in particular for maintenance operations of the members found in that zone (electrical, pneumatic, hydraulic, electronic, etc.), one proceeds as indicated in FIGS. 11 to 15.

One begins by removing the line of screws 51 situated on the upstream edge of the lower cowling 9, as indicated by arrow F1 of FIG. 11.

One then removes the screws connecting the two lateral edges of the lower cowling 9 to the respective edges of the upper cowling 7 and of the intermediate cowling 23 (of course, this order of removing the attachments is purely indicative).

One then separates the upstream edge of the lower cowling 9 from the angle irons 49 fastened downstream from the air inlet 17, as indicated by arrow F2 of FIG. 12.

One then slides the lower cowling 9 toward the front of the nacelle, as indicated by arrow F3 of FIG. 13, making it possible to release the axial pins 33 from their respective receptacles 47.

Lastly, one can radially separate the lower cowling 9 from the nacelle, as indicated by arrow F4 of FIGS. 14 and 15.

Once the lower cowling 9 is removed in this way, one can access the peripheral zone 15.

If one wishes to access the upper part of this peripheral zone 15, after having removed the lower cowling 9, one can access the fittings 39 of the intermediate cowling 23, and thus detach the rods 41 from said fittings.

One can then remove both the intermediate cowling 23 and the upper cowling 7, thereby completely freeing the peripheral zone of the fan casing 19.

As can be understood from the preceding, the nacelle according to the invention includes a cowling that can be placed and removed extremely simply, owing to removable fastening means.

No articulation, locking and opening maintenance rod system is necessary, which makes it possible to save in terms of weight, simplicity and cost.

It will also be noted that the assembly/disassembly of the lower cowling 9 is done easily due to the fact that this cowling does not act on the compression of the joints 55 and 57.

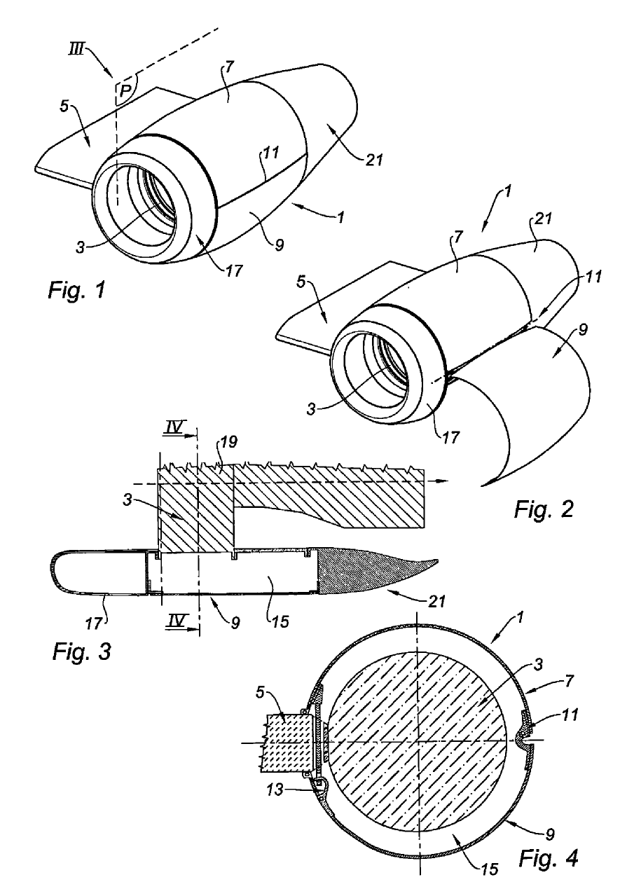

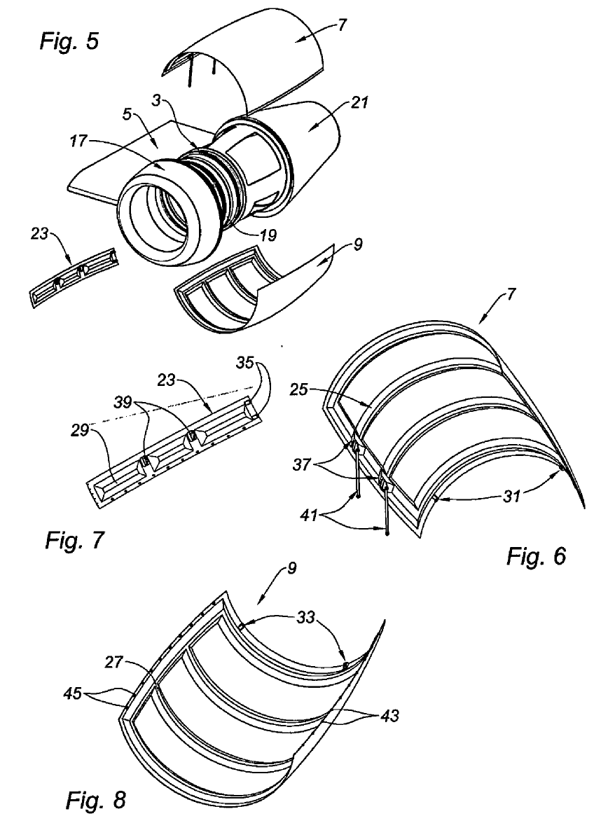

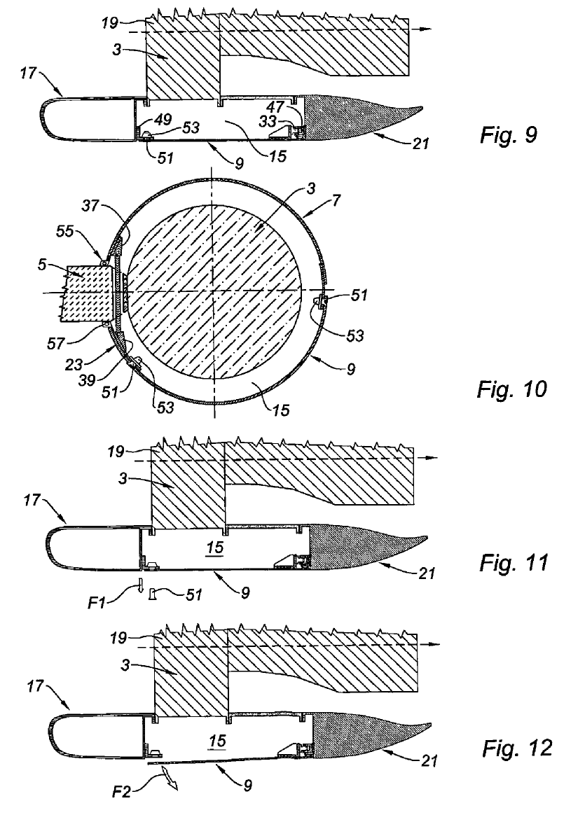

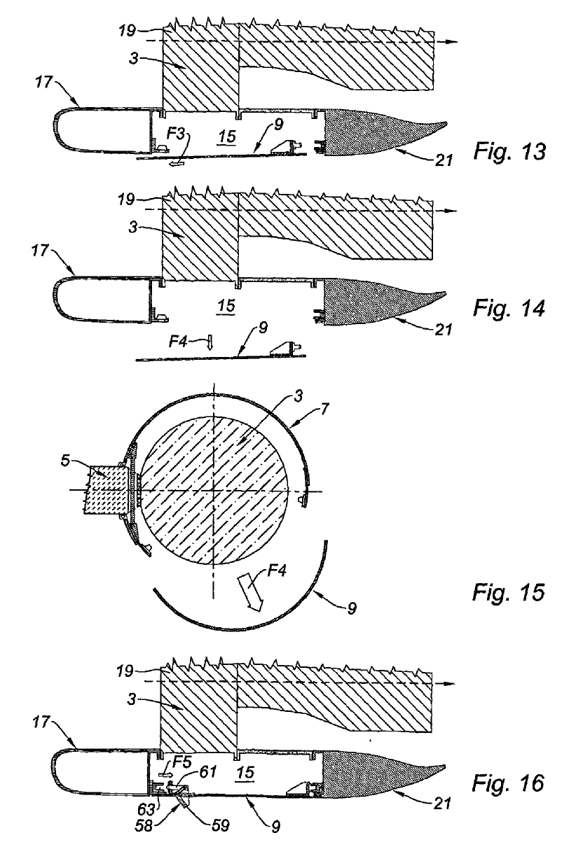

FIG. 16 indicates one possible alternative of the invention, in which a locking means 58 is provided only on the upstream edge of the lower cowling 9, such locking means typically being able to comprise actuating handles 59 acting on mobile pins 61 cooperating with the receptacles 63 integral with the air intake 17.

In this alternative, one does, however, keep the axial pins 33 and the removable fastening means of the screw/nut type for the lateral edges of the cowlings.

Of course, the present invention is in no way limited to the embodiments described and illustrated, provided as simple examples.

For instance, one may consider placing one or several quick access doors on the lower cowling 9, these doors for example being mounted pivotably on the cowling 9 using hinges.

1. A nacelle comprising:
a first cowling and a second cowling capable of covering in particular a zone situated around a casing of a fan of a turbojet engine; and
an intermediate cowling fixed to said first cowling so as to sandwich a support mast of said turbojet engine; wherein
said second cowling is attached on said intermediate cowling by removable fastening means.

2. The nacelle according to claim 1, further comprising pins for axial fastening of said first cowling and/or of said second cowling and/or of said intermediate cowling on a downstream part of said nacelle.

3. The nacelle according to claim 1, further comprising removable fastening means of said first cowling and/or of said second cowling and/or of said intermediate cowling on an upstream part of said nacelle.

4. The nacelle according to claim 1, further comprising locking means of said first cowling and/or of said second cowling and/or of said intermediate cowling on an upstream part of said nacelle.

5. The nacelle according to claim 3, wherein said removable fastening means comprises screws cooperating with nut casings.

6. The nacelle according to claim 1, wherein the means for fastening said intermediate cowling to said first cowling comprises fittings mounted on said cowlings and rods extending between said fittings.

7. The nacelle according to claim 1, further comprising joints fastened on edges of said intermediate cowling and of said first cowling that are designed to cooperate with said mast.

8. The nacelle according to claim 1, wherein said first cowling is an upper cowling and said second cowling is a lower cowling.

9. The nacelle according to claim 1, wherein said cowlings comprise reinforcing means.

10. The nacelle according to claim 2, wherein said downstream part comprises a thrust reverser.

11. The nacelle according to claim 3, wherein said upstream part comprises an air inlet.

12. The nacelle according to claim 4, wherein said upstream part comprises an air inlet.
